(19) United States
(12) Patent Application Publication
(10) Pub. No.: US 2013/0077618 A1
(43) Pub. Date: Mar. 28, 2013

(54) EXPEDITIOUS RESOURCE RESERVATION PROTOCOL

(71) Applicants: Paul E. Jones, Apex, NC (US); Gonzalo A. Salgueiro, Holly Springs, NC (US)

(72) Inventors: Paul E. Jones, Apex, NC (US); Gonzalo A. Salgueiro, Holly Springs, NC (US)

(73) Assignee: CISCO TECHNOLOGY, INC., San Jose, CA (US)

(21) Appl. No.: 13/287,285

(22) Filed: Nov. 2, 2011

Related U.S. Application Data
(60) Provisional application No. 61/538,278, filed on Sep. 23, 2011.

(51) Int. Cl. H04L 12/66

(52) U.S. Cl. 370/352

(57) ABSTRACT

Techniques are provided for making reservations between a calling device and one or more called devices using the Expeditious Resource Reservation Protocol (E-RSVP). An example technique involves sending an invite message from the calling device to one or more called devices over a data network. In response to the invite message, each of the called devices transmits a resource reservation message to the calling device. The resource reservation messages may be, for example, a Resource Reservation Protocol (RSVP) message. Based on the information in the received resource reservation messages, the calling device establishes reservations with each of the called devices.

### CROSS-REFERENCE TO RELATED APPLICATIONS

This application claims the benefit of U.S. Provisional Patent Application No. 61/538,278 filed on Sep. 23, 2011. The content of this provisional application is hereby incorporated by reference herein.

### TECHNICAL FIELD

The present disclosure relates to the reservation of resources in a network.

### BACKGROUND

A data network is a geographically distributed collection of nodes interconnected by communication links for transporting data (e.g., audio, video, etc.) between communication units (endpoints), such as personal computers, certain telephones, personal digital assistants (PDAs), video units/terminals and the like. Many types of data networks are available, such as local area networks (LANs) and wide area networks (WANs). LANs typically connect nodes over dedicated private communications links located in the same general physical location, such as a building or a campus. WANs typically connect large numbers of geographically dispersed nodes over long-distance communications links. The Internet is an example of a WAN that connects networks throughout the world, providing global communication between nodes on various networks.

In some data networks, a session protocol may be employed to establish a connection that supports a call (communication session) between a calling device and a called device. An example of a session protocol that is commonly used is the Session Initiation Protocol (SIP) which is defined in the Internet Engineering Task Force (IETF) Request For Comments (RFC) 3261. SIP operates at the application layer of the Open Systems Interconnection/Reference Model (OSI-RM) and is defined to initiate sessions between endpoints (e.g., SIP-based telephones) in a data network. Another protocol is the H.323 standard recommended by the International Telecommunication Union Telecommunication Standardization Sector (ITU-T). The H.323 standard defines a protocol used to provide audio-visual communication sessions on packet networks.

Some applications may incorporate a data flow configured to transfer time-sensitive traffic between a calling device and a called device in a data network. In these applications, a reservation may be established between the calling device and the called device to reserve network resources, thereby ensuring that a certain “quality of service” (QoS) is maintained for the data flow. A reservation is the allocation of networking devices, such as routers, switches, gateways, etc., in whole or in part, to process the specific data flow. QoS relates to the handling of traffic associated with a data flow to ensure that it is consistently and timely delivered. QoS is typically influenced by the amount of resources in a network that are dedicated to providing the delivery of traffic.

### BRIEF DESCRIPTION OF THE DRAWINGS

FIG. 1 is block diagram of an example data network in which devices are configured to make resource reservations through the use of the Expeditious Resource Reservation Protocol (E-RSVP).

FIG. 2 is a flow diagram illustrating operations for making reservations between a calling device and a called device in accordance with one example use of the E-RSVP.

FIG. 3 is a flow diagram illustrating operations for making reservations between a calling device and a called device in accordance with another example use of the E-RSVP.

FIG. 4 is a flow diagram illustrating operations for making reservations between a calling device and a called device in accordance with a still other example use of the E-RSVP.

FIG. 5 is a flow diagram illustrating operations for making reservations between a calling device and a called device in accordance with yet another example use of the E-RSVP.

FIG. 6 is a flowchart of the operations implemented by a calling device in accordance with one example use of the E-RSVP.

FIG. 7 is a flowchart of the operations implemented by a called device in accordance with another example use of the E-RSVP.

### DESCRIPTION OF EXAMPLE EMBODIMENTS

### Overview

Techniques are provided for making reservations between a calling device and one or more called devices using the Expeditious Resource Reservation Protocol (E-RSVP) described further below. An example technique involves sending an invite message from the calling device to one or more called devices over a data network. In response to the invite message, each of the called devices transmits a resource reservation message back to the calling device. The resource reservation message may be, for example, a Resource Reservation Protocol (RSVP) message. Based on the information in the received resource reservation message, the calling device establishes reservations with each of the called devices.

### Example Embodiments

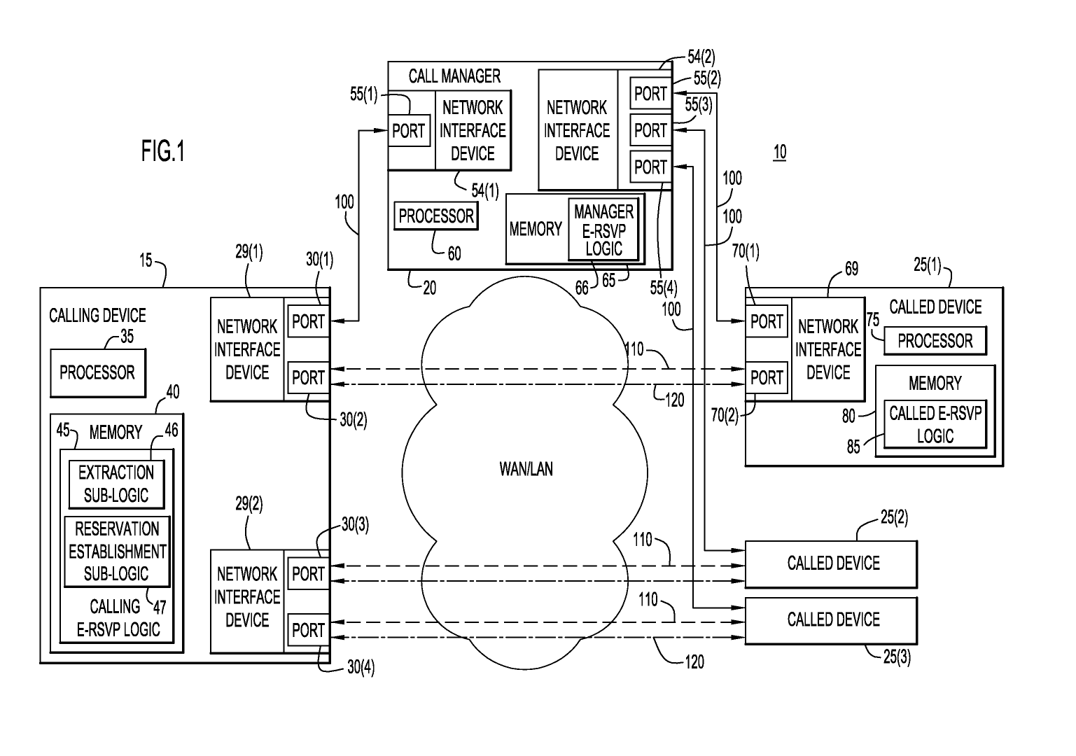

FIG. 1 is a block diagram of an example data network 10 in which devices are configured to make reservations through the implementation of a resource reservation protocol. One example of a resource reservation protocol is the Resource Reservation Protocol (RSVP). The RSVP is a network-layer protocol that enables applications to reserve resources for data flows in order to obtain a certain Quality of Service (QoS). Pursuant to RSVP, a data flow is a sequence of packets that have the same source address and the same destination address (unicast or multicast). In general, RSVP defines a “session” to be a data flow with a particular destination and transport-layer protocol. In one example, the so-called Expeditious-RSVP (E-RSVP) is referred to as a specific variation of the RSVP that is used according to the techniques described herein. A reservation is the allocation of networking devices, such as routers, switches, gateways, etc., in whole or in part, to process the specific data flow.

Data network 10 comprises a calling device 15, a call manager 20, and three called devices 25(1)-25(3). Calling device 15 comprises first and second network interface devices 29(1) and 29(2), respectively. Network interface device 29(1) comprises two ports 30(1) and 30(2), while network interface device 29(2) comprises two ports 30(3) and 30(4). As used herein, a port is simply an interface that enables a device to communicate with one or more other devices.

Calling device 15 further comprises a processor 35, and a memory 40. Memory 40 comprises calling E-RSVP logic 45 that includes extraction sub-logic 46 and reservation establishment sub-logic 47. Calling device 15 is a communication unit and may comprise, for example, a personal computer, different types of Internet Protocol (IP) telephones or other IP telephony-capable devices, a personal digital assistant (PDA), video unit/terminal and the like.

Call manager 20 comprises a first network interface device 54(1) and a second network interface device 54(2). Network interface device 54(1) comprises a port 55(1), while network interface device 54(2) comprises three ports 55(2), 55(3) and 55(4). Call manager 20 further comprises a processor 60, and a memory 65 that includes manager E-RSVP logic 66. Call manager 20 may be a server (proxy or back-to-back user agent (B2BUA)).

Called device 25(1) comprises a network interface device 69 including two ports 70(1) and 70(2). Called device 25(1) also comprises a processor 75, and a memory 80 comprising called E-RSVP logic 85. Called devices 25(2) and 25(3) comprise substantially the same elements as called device 25(1), but, for ease of illustration, the elements of called devices 25(2) and 25(3) have been omitted from FIG. 1. Called device 25(1) is a communication unit and may comprise, for example, a personal computer, different types of IP-telephones or IP telephony-capable devices, a personal digital assistant (PDA), video unit/terminal and the like.

It is to be appreciated that the example arrangement of FIG. 1 is merely illustrative and that other arrangements are possible. Additionally, calling device 15, call manager 20 and called devices 25(1)-25(3) may include other components as known in the art. For ease of illustration, any such known components have been omitted from FIG. 1.

Still referring to FIG. 1, there is a desire to make a call between calling device 15 and one of called devices 25(1)-25(3) over data network 90 which may be, for example, a local area network (LAN), wide area network (WAN), etc. As used herein, a call generally refers to a unidirectional or a bidirectional communication session between two endpoints (i.e., calling device 15 and one of called devices 25(1)-25(3)) and may involve the transfer of audio and/or video data, such as in a Voice over Internet Protocol (VoIP) call, video conference, etc. When initiating a call between a calling device and a called device, there may be a desire to establish resource reservations (e.g., a Resource Reservation Protocol (RSVP) reservation) prior to the answering of the call. The Internet Engineering Task Force (IETF) Request For Comments (RFC) 3312 entitled “Integration of Resource Management and Session Integration Protocol (SIP)” (hereinafter, “RFC 3312”) describes a method that allows such reservation establishment. In accordance with RFC 3312, prior to establishment of the RSVP reservation, a complete offer/answer exchange via SIP is required. More specifically, in accordance with RFC 3312, each device that may be called (called devices) receives a SIP offer from a calling device, responds to the calling device with another SIP message, referred to as an answer. The answer contains the IP address, port information, and status information relating to the desired reservation. RFC 3312 was designed for use with SIP proxies as the call manager, but is not readily adapted for use with back-to-back user agent call managers. This SIP signaling becomes extremely complicated when trying to allow a calling device to initiate a session and reserve bandwidth for the call, particularly when there is a plurality of called devices. Each called device needs to exchange the signaling messages before the call can be answered, each of which must be processed by all intermediaries in the signaling path (call managers) and, ultimately, by the calling device.

In the example techniques described herein, calling and called devices are configured to implement a protocol, referred to as the aforementioned Expeditious-Resource Reservation Protocol (E-RSVP), for establishing RSVP reservations with one another prior to the answering of a call. The E-RSVP allows for simplified reservation establishment, as compared to RFC 3312, because the SIP answer (required for RFC 3312) in response to the SIP offer, is not required. Instead, in accordance with the E-RSVP, in response to an initial message (e.g., INVITE message from a calling device), a called device is configured to immediately transmit an RSVP message (e.g., PATH message) to the calling device, and the called device does not send a session protocol answer. For ease of reference, examples provided herein will be described with reference to the use of the SIP as the initial session protocol. However, it is to be appreciated that the disclosed techniques may be readily implemented with H.323 or other session protocols.

In the example of FIG. 1, calling device 15 transmits an initial signal in accordance with the SIP. This message is referred to as an invite message (e.g., SIP INVITE), and is represented by arrow 100. Invite message 100 is transmitted from calling device 15 via port 30(1), and is received at port 55(1) of call manager 20. Call manager 20 then forwards invite message 100 to one or more called devices 25(1)-25(3) via ports 55(2), 55(3), and 55(4), respectively. As would be appreciated, the called devices 25(1)-25(3) may be, for example, different devices in a call center or all of a person's devices (e.g., desk phone, cell phone, computer, etc.).

The SIP provides for option tags within the header that may be used in invite message 100 to indicate that the calling device 15 desires to use the E-RSVP to establish reservations with called devices 25(1)-25(3). In other words, an advertisement may be added to the SIP header indicating that there is a requirement or a desire to use the E-RSVP. This advertisement may cause called devices 25(1)-25(3) to operate, as described below, to respond to invite message 100 with an RSVP message. This advertisement may be inserted into invite message 100 by calling device 15 through execution of calling E-RSVP logic 45, or by call manager 20 through execution of manager E-RSVP logic 66.

As noted above, another available protocol is H.323. If H.323 is used, the invite message is a SETUP message that is sent from calling device 15 to called device 25(1) via call manager 20. In H.323, there is a generic field in which the advertisement indicating optional or required use of the E-RSVP may be inserted.

The use of the SIP options tag and the H.323 generic data field are merely examples of mechanisms that may be used in accordance with the E-RSVP to indicate a desire or requirement to use the E-RSVP. It is to be appreciated other mechanisms for either protocol may be used in accordance with techniques described herein.

Invite message 100 is received by each of called devices 25(1)-25(3). For ease of illustration, only the subsequent operations of called device 25(1) are described herein. Upon receipt of invite message 100 via port 70(1), called device 25(1) is configured to directly transmit, via port 70(2), an RSVP PATH message to calling device 15 that includes the Internet Protocol (IP) address (i.e., the IP address of called device 25(1)) and other information usable by calling device 15 to communicate with called device 25(1). This information is sometimes referred to herein as addressing information for called device 25(1). The generation of this RSVP message with this addressing information is enabled through execution of called E-RSVP logic 85 by processor 75.

The RVSP PATH message transmitted by called device 25(1) is received by calling device 15 via port 30(2). Through the execution of extraction sub-logic 46 by processor 35, calling device 15 extracts or otherwise obtains the addressing information (IP address, etc.) from the received RSVP message.

Using the addressing information in the received RSVP PATH message, calling device 15 establishes an RSVP reservation with called device 25(1). To establish the RSVP reservation, calling device 15 transmits an RSVP message (e.g., RESV message) to called device 25(1). This transmission may be enabled through the execution of reservation establishment sub-logic 47 in memory 46. As described further below, called device 25(1) and calling device 15 may exchange additional RSVP messages to complete reservations between called device 25(1) and calling device 15. The exchange of the various RSVP messages is represented in FIG. 1 by arrow 110. The reservation established through use of the above described E-RSVP techniques is represented by arrow 120.

After the RSVP reservations between calling device 15 and called device 25(1) have been established, each called device 25(1)-25(3) will alert the user to the incoming call and send the signaling message to the calling device (as appropriate for the signaling protocol). Once one called device answers, the other called devices are disconnected and their respective reservations are released, thereby leaving a single call signaling path and only reservations between the calling device and the single called device (where the call was answered).

In the example of FIG. 1, certain operations are implemented through the execution of calling E-RSVP logic 45 (i.e., extraction sub-logic 46 and reservation establishment sub-logic 47), manager E-RSVP logic 66, and called E-RSVP logic 85 within memories 46, 65, and 80, respectively. As such, the example E-RSVP techniques are generally software techniques supported by the hardware of calling device 15, call manager 20, and called devices 25(1)-25(3), respectively. In an alternative arrangement, calling E-RSVP logic 45 (i.e., extraction sub-logic 46 and reservation establishment sub-logic 47), manager E-RSVP logic 66, and called E-RSVP logic 85 may be implemented as hardware elements, such as digital logic gates in one or more application-specific integrated circuits (ASICS). In such an alternative arrangement, the E-RSVP techniques are implemented substantially or fully in hardware.

Returning to the example of FIG. 1, memories 46, 65, and 80 may each comprise read only memory (ROM), random access memory (RAM), magnetic disk storage media devices, optical storage media devices, flash memory devices, electrical, optical, or other physical/tangible memory storage devices. The processors 35, 60 and 75 are, for example, microprocessors or microcontrollers that execute instructions for the calling E-RSVP logic 45, manager E-RSVP logic 66, and called E-RSVP logic 85, respectively. Thus, in general, the memories 46, 65, and 80 may each comprise one or more tangible computer readable storage media (e.g., a memory device) encoded with software comprising computer executable instructions and when the software is executed (by the respective processor 35, 60 and 75) it is operable to perform the operations described herein in connection with the calling E-RSVP logic 45, manager E-RSVP logic 66, and called E-RSVP logic 85, respectively.

In summary of the above, following receipt of the initial session protocol invite message 100, each of the called devices 25(1)-25(3) and the calling device 15 exchange various RSVP messages (e.g., PATH and RESV messages) to establish reservations between the calling device and the called devices. The example E-RSVP method reduces the signaling complexity, relative to RFC 3312, by eliminating a SIP answer to the invite message, therefore allowing for rapid establishment of RSVP. The E-RSVP techniques may be deployed with a plurality of protocols (e.g., SIP, H.323, and Extensible Messaging and Presence Protocol (XMPP)/Jingle), and provide interworking at the bearer level. In the E-RSVP techniques, the operations typically implemented through burdensome SIP signaling (in response to the invite) are eliminated through the use of enhanced RSVP signaling (i.e., RSVP signaling additions). This reduces the processing burden on the calling device.

As noted above, FIG. 1 is merely an example of one of many different data networks in which the E-RSVP may be implemented. In one specific alternative data network, the call manager may be eliminated and the calling device and called devices may communicate directly with one another over the network (or through one or more different intermediate devices).

Additionally, in the example of FIG. 1, called devices 25(1)-25(3) are configured for bi-directional communication. In an alternative example, called devices 25(1)-25(3) may be configured only to receive messages. This may be the case, for example, when automated calls are made to a called device. In such circumstances, in response to a received invite message, the called device is configured to send a PATH message that asks for the reservation of zero bandwidth (because it does not need to communicate back to the calling device). As such, the reservation is still established, as described elsewhere herein, but is for zero bandwidth. This “zero bandwidth” example is merely one circumstance that may be used to deal with devices that are only receiving (and not transmitting) data packets.

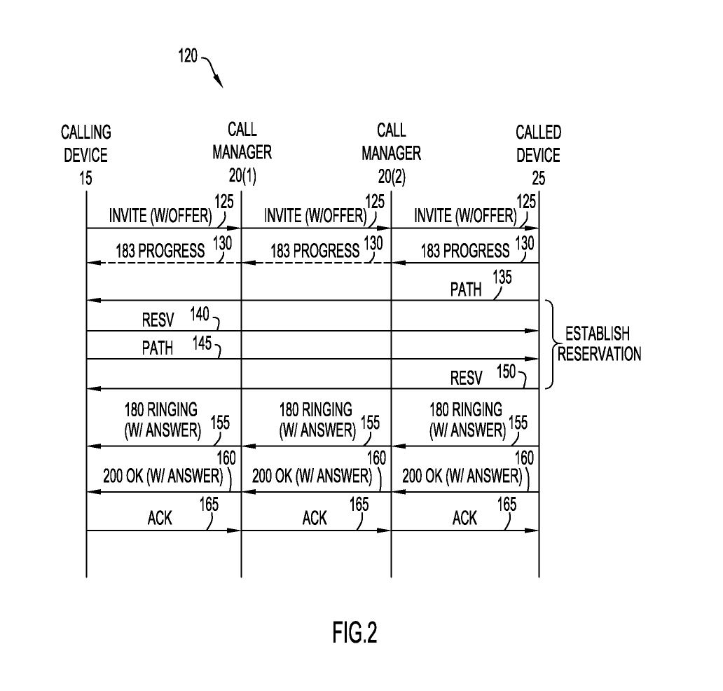

FIG. 2 is a flow diagram 120 illustrating the use of one example E-RSVP technique for making reservations between a calling device and a called device prior to the answering of a call. For ease of illustration, the example of FIG. 2 will be described with reference to a modified arrangement of FIG. 1. More specifically, in the example of FIG. 2, data network 10 comprises the calling device 15, a first call manager 20(1), a second call manager 20(2), and a called device 25. As noted above, the use of call managers 20(1) and 20(2) is merely illustrative, and the call managers are not required in alternative arrangements.

As shown, calling device 15 first sends an SIP INVITE message 125 (with an offer) to call manager 20(1). The offer in the INVITE message 125 is, as noted above, an advertisement indicating a requirement or a desire to use the E-RSVP to establish reservations between calling device 15 and called device 25. Call manager 20(1) forwards INVITE message 125 to call manager 20(2) which then forwards the INVITE message 125 to called device 25. In the example of FIG. 2, called device 25 responds to call manager 20(2) with a progress message 130 indicating that it is attempting to send an RSVP message to calling device 15. As shown in FIG. 2, the progress message 130 may be a SIP 183 Session Progress Message, referred to as a 183 progress message. In certain circumstances, call manager 20(2) may forward the 183 progress message to call manager 20(1) which may then forward the message to calling device 15. It is to be appreciated that, as represented by the dotted lines in FIG. 2, the forwarding of progress message 130 to calling device 15 is optional.

After called device 25 receives INVITE message 125, called device 25 sends an RSVP PATH message 135 directly to calling device 15. The PATH message 135 includes addressing information (i.e., source IP address, etc.) that is usable by calling device 15 to communicate with called device 25. Using the addressing information in the PATH message 135, calling device 15 transmits an RSVP reservation (RESV) message 140 and a PATH message 145 to called device 25. Establishment of reservations between calling device 15 and called device 25 is completed by called device 25 transmitting an RESV message 150 back to calling device 15.

In this arrangement, calling device 15 conveys media and media control address information to called device 25. Called device 25 then uses this information to formulate the PATH message 135 to send to the calling device. As noted above, included in the PATH message 135 is the addressing information that calling device 15 uses to generate RESV message 140 and to also generate PATH message 145 for transmission to called device 25.

It should be appreciated that the order of the RSVP messages of FIG. 2 is merely illustrative and that other orders of the messages may be used in alternative arrangements. For example, in one alternative arrangement, the receiver of the first PATH message (i.e., the calling device) may, for example, send a PATH message and receive a RESV message before sending a RESV message.

After the RSVP reservations between calling device 15 and called device 25 are established, called device 25 may “ring” to inform a party (e.g., a user, processor, or other device) at the called device of the new call. Called device 25 also transmits a ringing message 155, such as a SIP 180 ringing message, to calling device 15 via call managers 20(1) and 20(2). This ringing message 180 functions an implicit indicator to call managers 20(1) and 20(2) that the reservations have been successfully established. Called device 25 also transmits a success message 160, such as a SIP 200 OK message, to calling device 15 via call managers 20(1) and 20(2). Calling device 15 may respond to called device 25, via call managers 20(1) and 20(2), with an acknowledgement (ACK) message 165.

FIG. 2 illustrates an example in which only one called device 25 is present. If multiple called devices are present, ringing messages 155 would be sent by each called device. In certain such circumstances, the call manager 20(2) may individually forward the ringing messages 155 from each called device to calling device 15. In other such circumstances, the call manager 20(2) may hold all of the ringing messages 155 until all are received, then call manager 20(2) would provide one notice to calling device 15.

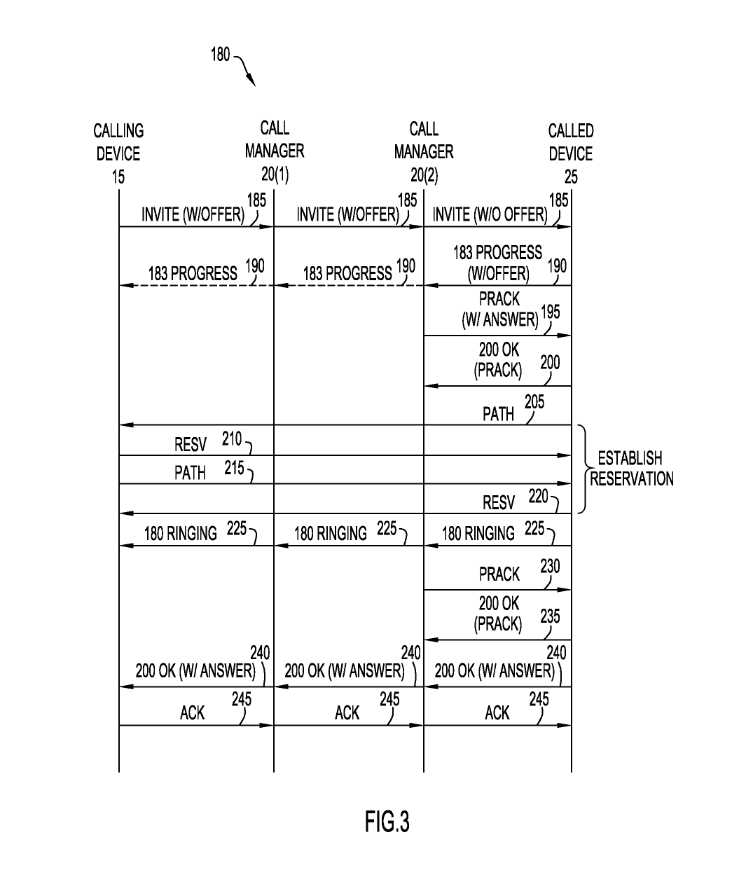

FIG. 3 is a flow diagram 180 illustrating another example use of the E-RSVP techniques for making reservations between a calling device and a called device. For ease of illustration, the example of FIG. 3 will be described with reference to a modified arrangement of FIG. 1 in which the data network 10 comprises a calling device 15, a first call manager 20(1), a second call manager 20(2), and a called device 25.

As shown, calling device 15 first sends an SIP INVITE message 185 (with an offer) to call manager 20(1). That is, similar to the example of FIG. 2, the INVITE message 185 includes an advertisement indicating a requirement or a desire to use E-RSVP to establish a reservation between calling device 15 and called device 25. Call manager 20(1) forwards the INVITE message 185 to call manager 20(2) which then forwards INVITE message 185 (without the offer) to called device 25. In this example, because called device 25 does not receive media information from the call manager (i.e., it did not receive the offer), the called device responds to call manager 20(2) with a progress message 190 that includes an offer that is an advertisement to use the E-RSVP to establish a reservation with calling device 15. The progress message 190 may be a 183 progress message. In certain circumstances, call manager 20(2) may forward the 183 progress message to call manager 20(1) which may then forward the message to calling device 15. It is to be appreciated that, as represented by the dotted lines in FIG. 2, forwarding progress message 190 to calling device 15 is optional.

In response to receipt of progress message 190, call manager 20(2) sends a provisional acknowledgement 195, such as the SIP Provisional Response Acknowledgement (PRACK), to called device 25 indicating if the E-RSVP may be implemented and providing called device 25 with the desired media information. Called device 25 indicates success with a message 200 that may be a 200 OK (PRACK) message.

As shown, called device 25 then sends an RSVP PATH message 205 directly to calling device 15. The PATH message 205 includes the addressing information usable by calling device 15 to communicate with called device 25. Using the addressing information in the PATH message 205, calling device 15 transmits an RSVP RESV message 210 and a PATH message 215 to called device 25. Establishment of the reservations between calling device 15 and called device 25 is completed by called device 25 transmitting an RESV message 220 back to calling device 15.

After the RSVP reservations are established, called device 25 may “ring” to inform a party at the called device of the new call. Called device 25 also transmits a ringing message 225, such as a SIP 180 ringing message, to calling device 15 via call managers 20(1) and 20(2). Call manager 20(2) responds to the ringing message 225 with an acknowledgement message 230 (i.e., PRACK message). The acknowledgement message 230 is followed by a success message 235, such as a 200 OK (PRACK) message, from called device 25 to call manager 20(2). A 200 OK message 140 is then sent from called device 25 to calling device 15 via call managers 20(1) and 20(2). Calling device 15 may respond with an acknowledgement (ACK) message 245.

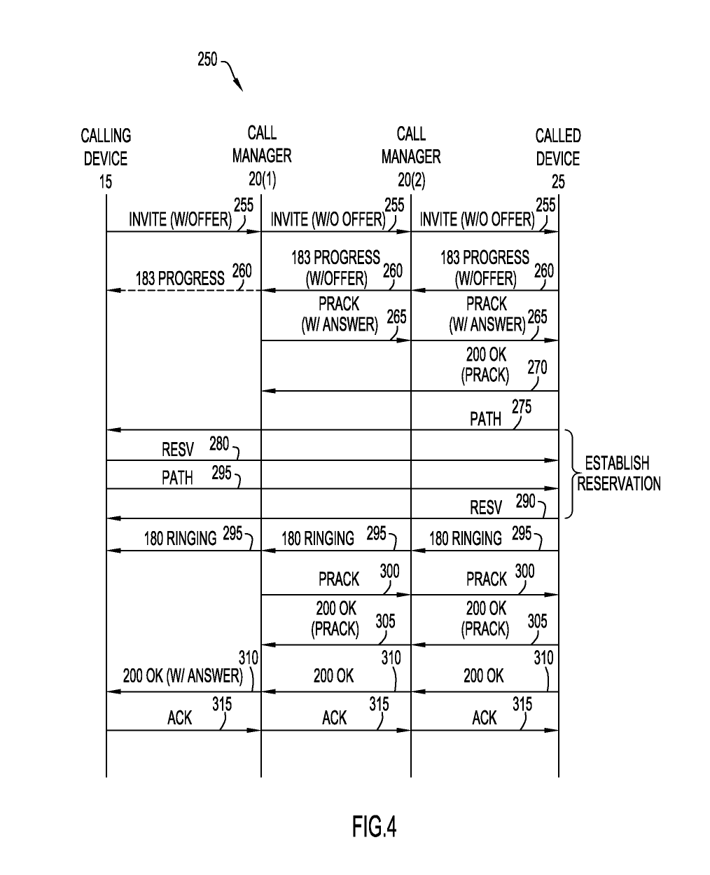

FIG. 4 is a flow diagram 250 illustrating another example use of the E-RSVP techniques for making reservations between a calling device and a called device. For ease of illustration, the example of FIG. 4 will be described with reference to a modified arrangement of FIG. 1 in which the data network 10 comprises a calling device 15, a first call manager 20(1), a second call manager 20(2), and a called device 25.

As shown, calling device 15 first sends a SIP INVITE message 255 (with an offer) to call manager 20(1). That is, similar to the example of FIG. 2, the INVITE message 255 includes an advertisement indicating a requirement or a desire to use E-RSVP to establish reservations between calling device 15 and called device 25. Call manager 20(1) forwards the INVITE message 255 to call manager 20(2) (without an offer) which then forwards INVITE message 255 to called device 25. In the example of FIG. 4, because call manager 20(1) sent the INVITE without the offer, called device 25 responds to call manager 20(1) (via call manager 20(2)) with a progress message 260 that includes an offer that is an advertisement to use the E-RSVP to establish a reservation with calling device 15. The progress message 260 may be a 183 progress message. In certain circumstances, call manager 20(1) may forward the 183 progress message to calling device 15. It is to be appreciated that, as represented by the dotted lines in FIG. 4, forwarding progress message 260 to calling device 15 is optional.

In response to receipt of progress message 260, call manager 20(1) sends a provisional acknowledgement 265, such as the SIP Provisional Response Acknowledgement (PRACK), to called device 25 (via call manager 20(2)) indicating if the E-RSVP may be implemented, and providing the desired media information. Called device 25 indicates success with a message 270 that may be a 200 OK (PRACK) message.

As shown, called device 25 then sends an RSVP PATH message 275 directly to calling device 15. The PATH message 275 includes the addressing information usable by calling device 15 to communicate with called device 25. Using the addressing information in the PATH message 275, calling device 15 transmits an RSVP RESV message 280 and a PATH message 285 to called device 25. Establishment of the reservations between calling device 15 and called device 25 is completed by called device 25 transmitting an RESV message 290 back to calling device 15.

After the RSVP reservations are established, called device 25 may “ring” to inform a party at the called device of the new call. Called device 25 also transmits a ringing message 295, such as a SIP 180 ringing message, to calling device 15 via call managers 20(1) and 20(2). Call manager 20(1) responds to the ringing message 295 with an acknowledgement message 300 (i.e., PRACK message). The acknowledgement message 300 is followed by a success message 305, such as a 200 OK (PRACK) message, from called device 25 to call manager 20(1), as well as a success message 310 that call manager 20(1) forwards to calling device 15. Calling device 15 may respond with an acknowledgement (ACK) message 315.

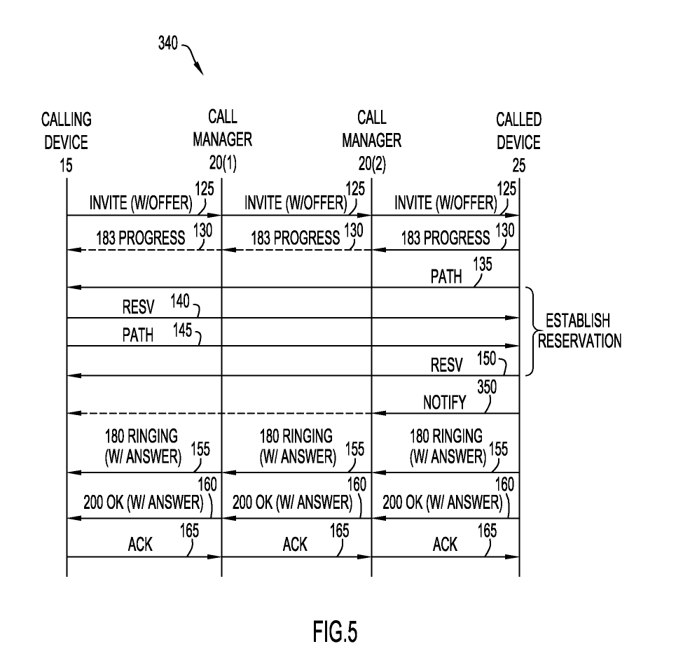

FIG. 5 is a flow diagram 340 illustrating another example use of the E-RSVP techniques for establishing a reservation between a calling device and a called device. In the example of FIG. 5, the initial signaling and the establishment of the reservations is substantially the same as described above with reference to FIG. 2. However, in this example, an explicit completion notification, shown in FIG. 5 as NOTIFY message 350, is provided to call manager 20(2) after establishment of the reservations. This explicit notification may take any one of a number of different forms, and is configured to indicate to the call manager(s) that the reservation has been completed.

The examples of FIGS. 2-5 have been described with reference to use of the SIP. It is to be appreciated that these examples are merely illustrative, and the described techniques may be implemented with H.323 or other session protocols.

Additionally, merely for ease of illustration, FIGS. 2-5 demonstrate the establishment of reservations between a calling device and one called device. It is to be appreciated that these examples may be expanded/modified to include the establishment of reservations between a calling device and multiple called devices.

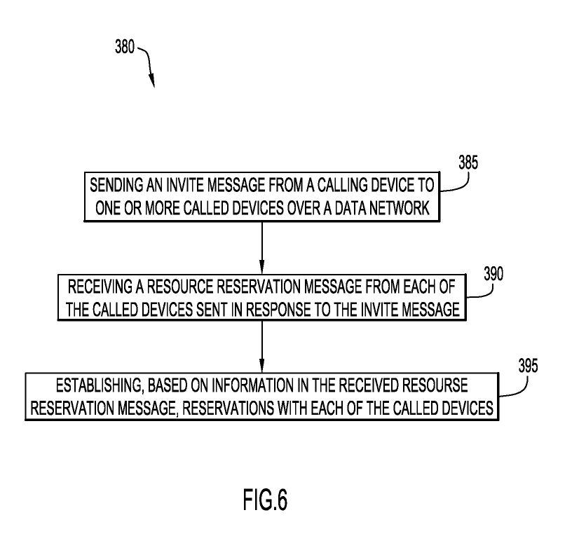

FIG. 6 is a flowchart of a method 380 in which resource reservations, such as RSVP reservations, are established between a calling device and one or more called devices through the implementation of E-RSVP. Method 380 of FIG. 6 is substantially implemented on a calling device. At 385, an invite message is sent from a calling device to one or more called devices over a data network. At 390, a resource reservation message (e.g., PATH message) is received from each of the called devices sent by the called devices in response to their reception of the invite message from the calling device. This resource reservation message includes addressing information for the called devices. At 395, based on addressing information in the received resource reservation messages, resource reservations are established with each of the called devices. In certain circumstances, the calling device receives the resource reservation message without receiving any prior signaling messages that contain addressing information for the called device (e.g., without receiving an answer to a previously sent invite), while in other circumstances the calling device receives only intermediate replies (e.g., progress messages or trying messages that do not contain addressing information), but not an answer. In one example of FIG. 6, the established reservations are RSVP reservations and the calling device is configured to establish the RSVP reservations with each of the called device by sending an RSVP RESV message to each of the called devices, sending an RSVP PATH message to each of the called devices, and receiving an RSVP RESV message from each of the called devices.

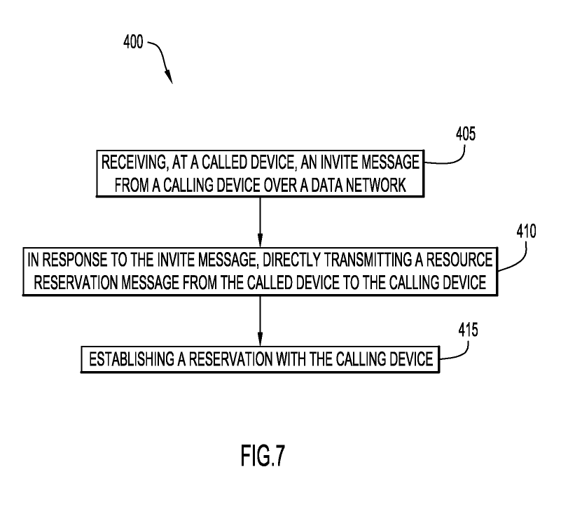

FIG. 7 is a flowchart of a method 400 in which resource reservations, such as RSVP reservations, are established between a calling device and one or more called devices through the implementation of E-RSVP. Method 400 of FIG. 7 is substantially implemented on a called device. At 405, an invite message (with an offer) from a calling device is received over a data network. At 410, in response to the invite message, the called device directly transmits a resource reservation message (e.g., PATH message) to the calling device. This resource reservation message includes addressing information for the called devices. At 415, the resource reservations are established with the calling device (e.g., by receiving a return PATH message from the calling device and exchanging RESV messages with the calling device). In certain circumstances, the called device sends the resource reservation message without sending any prior signaling messages that contain addressing information (i.e., without sending an answer to a previously received invite). In other circumstances, the called device sends only intermediate messages in accordance with a session protocol that do not contain addressing information. In one example of FIG. 7, the reservation is an RSVP reservation.

One difference between the example E-RSVP techniques and the existing use of RSVP is that the communicating devices (e.g., calling device 15 and called devices 25(1)-25(3)) exchange minimal information via session protocol signaling. For example, a SIP device sends an INVITE with an “offer” and an answer to this offer is not sent by the called devices prior to sending a PATH message back to the calling device. However, a reservation is established before the called device rings (i.e., notifies a user of the call) using RSVP flows and, once the reservations are established, an answer may be sent. A similar approach may be used for H.323, wherein fastStart elements convey the media and media control addresses to the called device and RSVP procedures are then completed before the called device rings.

Endpoints (calling and called devices) that support the E-RSVP are generally prepared to receive multiple PATH messages from multiple remote devices. This is generally desired since a call may be split (i.e., be “forked”) and multiple called devices may be sent an invite message in parallel. This is likewise possible with H.323 or XMPP/Jingle, and may likely be implemented with newer protocols like H.325. This ability to receive multiple PATH messages and the ability to respond to them with a RESV message, without further call control signaling exchanges, is one difference between the E-RSVP and the existing use of RSVP within multimedia communication systems.

As noted above, in certain examples, the RSVP messages (i.e., PATH/RESV) messages are used to establish reservations between a calling device and one or more called devices. As noted above, in accordance with the E-RSVP, a calling device responds to the called device with a PATH message. However, any subsequent PATH and RESV messages may be sent in different orders. In some circumstances, PATH/RESV messages may be sent without waiting for replies, thereby enabling faster establishment of reservations.

Since multiple called devices may attempt to establish reservations, the E-RSVP implementations may use different techniques to reduce the amount of bandwidth that is reserved as a result of the RSVP reservations. These techniques may, for example, allow bandwidth pooling (via a bandwidth pooling identifier (ID)) or use a resource sharing identifier to reduce the bandwidth reserved before the call is made. In bandwidth pooling, each of the called devices send PATH messages having the same bandwidth pooling ID assigned, for example, by the calling device. This allows the routers to know that only one call will be established, and, as such, the routers will only reserve enough bandwidth to service one call. More generally, these techniques enable the devices (e.g., called devices) to provide an indication to routers within the data network that each of the flows resulting from the various reservations is, in practice, the same reservation because only one reservation will be used for the call and the other reservations will be subsequently terminated.

Furthermore, to help safeguard against accepting PATH messages from devices that are not true called parties, the E-RSVP implementations may, for example, insert a Session Identifier, a security token, or other information into the initial signaling message (INVITE in the case of SIP) and that should be reflected in the RSVP PATH message for subsequent comparison. Various techniques may be used to construct a unique identifier that the calling party can recognize.

It would be appreciated that various systems could make use of different techniques to employ E-RSVP. For example, as noted above, the E-RSVP techniques may be used in systems implemented in accordance with the SIP, the H.323 standard, etc.

The above description is intended by way of example only.

What is claimed is:

1. A method comprising:
sending an invite message from a calling device to a called device over a data network;
receiving a resource reservation message, sent by the called device in response to the invite message, that includes addressing information for the called device; and
establishing, based on the addressing information in the received resource reservation message, a reservation with the called device.

2. The method of claim 1, wherein receiving the resource reservation message comprises:
receiving the resource reservation message without receiving any signaling messages that include addressing information from the called device.

3. The method of claim 1, wherein sending the invite message comprises:
sending an INVITE message in accordance with the Session Initiation Protocol.

4. The method of claim 1, wherein sending the invite message comprises:
sending a SETUP message in accordance with the H.323 standard.

5. The method of claim 1, wherein sending the invite message comprises:
sending the invite message to a call manager for forwarding to the called device.

6. The method of claim 1, wherein receiving the resource reservation message from the called device comprises:
receiving a Resource Reservation Protocol (RSVP) PATH message from the called device.

7. The method of claim 6, wherein establishing the reservation with the called device comprises:
sending an RSVP RESV message to the called device;
sending an RSVP PATH message to the called device; and
receiving an RSVP RESV message from the called device.

8. The method of claim 1, wherein establishing the reservation with the called device occurs prior to ringing of the called device.

9. A method comprising:
receiving, at a called device, an invite message from a calling device over a data network;
in response to the invite message, directly transmitting a resource reservation message including addressing information from the called device to the calling device; and
establishing a reservation with the calling device.

10. The method of claim 9, wherein transmitting the resource reservation message comprises:
transmitting the resource reservation message, in response to the invite message, without transmitting any signaling messages that include addressing information.

11. The method of claim 9, wherein receiving the invite message comprises:
receiving a forwarded invite message from a call manager.

12. The method of claim 9, further comprising:
after establishing the reservation, explicitly notifying the call manager that the reservation has been established.

13. The method of claim 9, wherein transmitting the resource reservation message comprises:
transmitting a Resource Reservation Protocol (RSVP) PATH message from the called device to the calling device.

14. The method of claim 13, wherein establishing the reservation with the calling device comprises:
receiving an RSVP RESV message from the calling device;
receiving an RSVP PATH message from the calling device; and
sending an RSVP RESV message to the calling device.

15. The method of claim 14, further comprising:
sending a ringing message to the calling device.

16. The method of claim 9, further comprising:
providing an indication to one or more routers in the data network that the reservation is a same reservation as one or more other reservations established in the network.

17. An apparatus comprising:
one or more network interface devices each comprising one or more ports; and
a processor coupled to the one or more network interface devices and configured to send an invite message to a called device over a data network, receive a resource reservation message, sent by the called device in response to the invite message, that includes addressing information for the called device, and establish, based on the addressing information in the received resource reservation message, a reservation with the called device.

18. The apparatus of claim 17, wherein the processor is configured to receive a Resource Reservation Protocol (RSVP) PATH message from the called device.

19. The apparatus of claim 18, wherein to establish the reservation, the processor is configured to send an RSVP RESV message to the called device, send an RSVP PATH message to the called device, and receive an RSVP RESV message from the called device.

20. The apparatus of claim 17, wherein the processor is configured to receive the resource reservation message without receiving any signaling messages that contain addressing information.

21. One or more computer readable storage media encoded with software comprising computer executable instructions and when the software is executed operable to:
send an invite message from a calling device to a called device over a data network;
receive a resource reservation message, sent by the called device in response to the invite message, that includes addressing information for the called device; and
establish, based on the addressing information in the received resource reservation message, a reservation with the called device.

22. The computer readable storage media of claim 21, wherein the instructions operable to receive a resource reservation message comprise instructions operable to:
receive the resource reservation message without receiving any signaling messages that contain addressing information.

23. The computer readable storage media of claim 21, wherein the instructions operable to receive a resource reservation message comprise instructions operable:
receive a Resource Reservation Protocol (RSVP) PATH message from the called device.

24. The computer readable storage media of claim 23, wherein the instructions operable to establish the reservations with the called device comprise instructions operable to:
send an RSVP RESV message to the called device;
send an RSVP PATH message to the called device; and
receive an RSVP RESV message from the called device.
